(19) United States
(12) Patent Application Publication
(10) Pub. No.: US 2011/0142128 A1
(43) Pub. Date: Jun. 16, 2011

(54) METHOD AND APPARATUS INTERLEAVING PIXEL OF REFERENCE IMAGE WITHIN SINGLE BANK OF FRAME MEMORY, AND VIDEO CODEC SYSTEM HAVING THE SAME

(75) Inventors: Suk Ho LEE, Daejeon (KR); Seong Mo Park, Daejeon (KR); Seung Hyun Cho, Daejeon (KR); Nak Woong Eum, Daejeon (KR)

(73) Assignee: ELECTRONICS AND TELECOMMUNICATIONS RESEARCH INSTITUTE, Daejeon (KR)

(21) Appl. No.: 12/958,093

(22) Filed: Dec. 1, 2010

(30) Foreign Application Priority Data
Dec. 10, 2009 (KR) 10-2009-0122188

(51) Int. Cl. H04N 11/04

(52) U.S. Cl. 375/240.13; 375/240.01; 375/E07.243

(57) ABSTRACT

A method and apparatus for interleaving pixels of a reference frame within a single bank of a frame memory in a video codec, and a video codec system including the same are provided. The method for interleaving pixels of a reference image within a single bank of a frame memory includes: interleaving pixel data of a reference image as a filter output of a restoration image required for video processing by column of a macro block; and storing the interleaved pixel data within a single bank of a frame memory by page.

### CROSS-REFERENCE TO RELATED APPLICATIONS

This application claims the priority of Korean Patent Application No. 10-2009-0122188 filed on Dec. 10, 2009, in the Korean Intellectual Property Office, the disclosure of which is incorporated herein by reference.

### BACKGROUND OF THE INVENTION

1. Field of the Invention

The present invention relates to a method and apparatus for interleaving pixels of a reference frame within a single bank of a frame memory in a video codec, and a video codec system having the same.

2. Description of the Related Art

A reference image is a result value obtained by creating a reconstruction image by adding a decoded residual value to an image formed through inter-prediction or intra-prediction and then deblocking-filtering the reconstruction image in order to reduce distortion between macro blocks according to a video codec. Here, the reference image is re-used in the event of inter-prediction of a next frame, and the size of the created reference image varies depending on the resolution of an image. However, because the amount of pixel data is large, a large capacity frame memory such as an SDRAM or a DDR SDRAM is used.

Unlike an SRAM, the SDRAM requires a certain latency in reading data. Thus, a read latency (T_{READ}) generated in reading a reference image (or reference video) for a motion estimation or motion compensation is a factor in degrading the overall performance of a video codec.

Thus, the present invention provides a method and apparatus for interleaving pixels of a reference image within a single bank of a frame memory capable of minimizing latency, and a video codec system having the same.

In order to store a reference image of a video codec, a large capacity frame memory such as an SDRMA or a DDR SDRAM is used because of the large amount of pixel data. In general, a frame memory includes a plurality of banks having a certain page size and a row address size. In reading data, data is retrieved after a certain time of read latency t_{RCD} (Active-to-Read Delay) and CAS latency (CL) following an active command (a row address active of a particular bank). Unlike an SRAM, this requires a delay time of T_{READ} (t_{RCD}+CL) in reading data, and as a clock frequency increases, the CAS latency (CL) also increases, causing a problem in that more delay time is required to read data.

Thus, in an effort to solve the problem, a multi-bank interleaving technique has been introduced to continuously read inter-bank data by removing a delay time by using a pipeline scheme in which, while data is being read from one bank, a command for reading data of another bank is transmitted in advance.

However, the effect of multi-bank interleaving is reduced when a burst length is smaller than a CL cycle, which, thus, requires a special multi-port memory controller supporting multi-bank interleaving, unlike a general memory controller, and this leads to additional complexity in implementation. Also, an additional data transmission device for distributedly storing required pixel data in each bank is required in terms of video codec processing characteristics.

### SUMMARY OF THE INVENTION

An aspect of the present invention provides a method and apparatus for interleaving pixels of a reference image within a single bank of a frame memory capable of solving the problem of a degradation of the performance of an overall system due to latency (t_{RCD}+CL) potentially generated in reading a reference image, which is required for a motion estimation or motion compensation in processing an image, from a frame memory such as an SDRAM or a DDR SDRAM, and a video codec system having the same.

Another aspect of the present invention provides a method and apparatus for interleaving pixels of a reference image within a single bank of a frame memory capable of minimizing a memory read latency (T_{READ}) while using a general single-port memory controller, rather than a special multi-port memory controller, and improving the performance of an overall video codec by securing a memory bandwidth, and a video codec system having the same.

According to an aspect of the present invention, there is provided a method for interleaving pixels of a reference image within a single bank of a frame memory, including: interleaving pixel data of a reference image as a filter output of a restoration image required for video processing by column of a macro block; and storing the interleaved pixel data within a single bank of a frame memory by page.

According to another aspect of the present invention, there is provided an apparatus for interleaving pixels of a reference image within a single bank of a frame memory, including: a column address generator generating a column address for storing pixel data of a reference image as a filter output of a restoration image required for video processing in a frame memory; and a row address generator generating a row address for storing the pixel data of the reference image in the frame memory, wherein the pixel data of the reference image is interleaved by column of a macro block according to a column address and a row address generated from the column address generator and the row address generator, respectively, and stored within the single bank of the frame memory by page.

According to another aspect of the present invention, there is provided a video codec system including: an inter-prediction unit predicting an image by estimating a motion between original images from a previous image; an intra-prediction unit predicting an image in the original image; a coding unit coding the difference between the image predicted by the inter-prediction unit or the intra-prediction unit and the original image to create a coded stream; a decoding unit adding a decoded residual value to the image predicted by the inter-prediction unit or the intra-prediction unit to restore the image; a deblocking filter filtering the restored image to eliminate a blocking phenomenon; a pixel interleaving device interleaving pixel data of the filtered image by row of a macro block; a frame memory storing the interleaved pixel data of the image in a single bank by page; and a memory controller storing the interleaved pixel data of the image in the frame memory, and providing the pixel data stored in the frame memory to the inter-prediction unit according to a consecutive read command upon receiving a corresponding request from the inter-prediction unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view for explaining a delay time generated in reading data from a general frame memory;

FIG. 2 is a view for explaining the storing of a reference image by frame according to a size thereof, and a cycle required for reading data by macro block according to the related art;

FIG. 3 is a schematic block diagram of a pixel interleaving device according to an exemplary embodiment of the present invention;

FIG. 4 is a schematic block diagram of a video codec system according to an exemplary embodiment of the present invention;

FIG. 5 is a view for explaining the sequential process of storing pixel data present in one macro block in a page of a single bank by column according to an exemplary embodiment of the present invention;

FIG. 6 is a view illustrating the number of macro blocks required for motion estimation or motion compensation;

FIG. 7 is a view illustrating the overall reference frame including the sizes of reference macro blocks of a filtered luminance image according to positions of the macro blocks; and

FIG. 8 is a view for explaining the process of retrieving data according to a read command according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

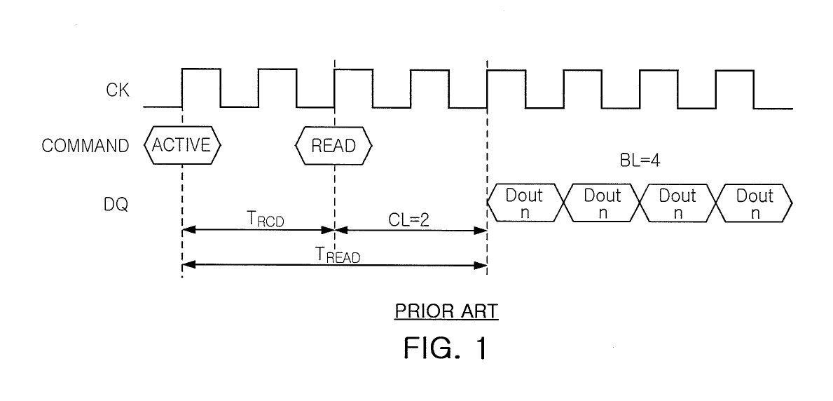

FIG. 1 is a view for explaining a delay time (or latency) generated in reading data from a general frame memory.

With reference to FIG. 1, when data is read from a large capacity frame memory such as an SDRAM memory or a DDR SDRAM, a read command (READ) defining a burst length (BL) and a memory address is given after the lapse of a certain time of read latency (t_{RCD}) following a row active command (ACTIVE), and data by the burst length (BL) is retrieved after the lapse of a certain time of CAS latency (CL) following the read command (READ). Thus, when the data is read from the frame memory, a delay time (or latency) of T_{READ} (t_{RCD}+CL) is required.

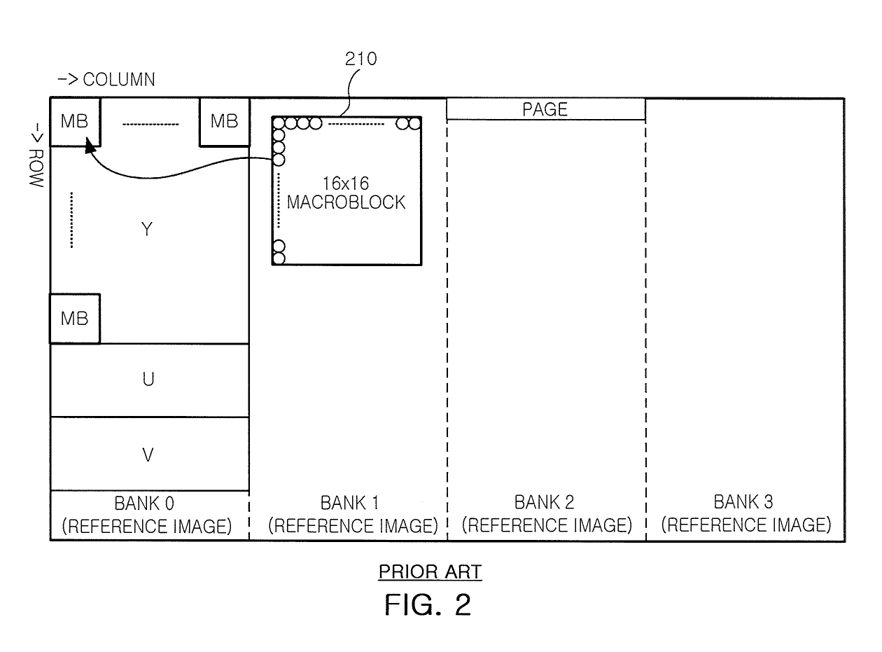

FIG. 2 is a view for explaining storing a reference image by frame according to a size thereof, and a cycle required for reading data by macro block according to the related art.

With reference to FIG. 2, a macro block 210 of a luminance component includes 16×16 pixels (8 bits), and in general, one pixel is expressed as 1 byte in a video system. Thus, the number of total bytes of one macro block is 256 bytes ((16×1 byte)×16).

The frame memory, such as the SDRAM or the DDR SDRAM, stores 4 bytes per column (×32), and in this case, when it is assumed that delay cycles required for reading the memory are t_{RCD}=3 and CL=3, one macro block occupies 16 columns and 16 rows in the frame memory, resulting in a situation in which a data read latency of six cycles is additionally required each time the addresses of each row are accessed, and accordingly, a total of 96 cycles [6 cycles (t_{RCD}+CL)×16 columns] is required. Thus, the related art has a problem in that as the frequency increases, the CAS latency (CL) is increased to further degrade the performance of the overall system.

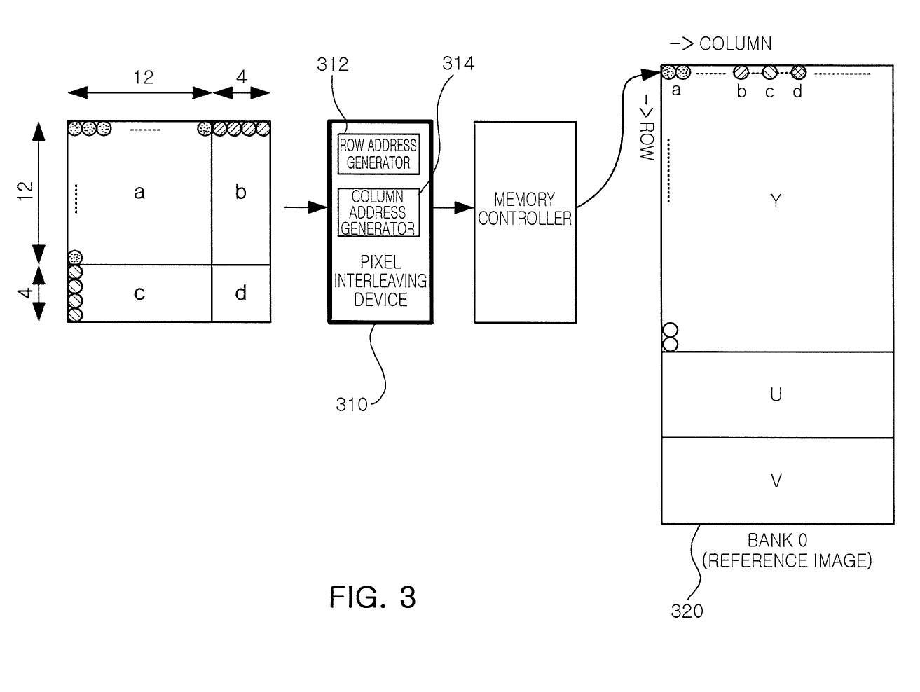

FIG. 3 is a schematic block diagram of a pixel interleaving device according to an exemplary embodiment of the present invention.

With reference to FIG. 3, a pixel interleaving device 310 according to an exemplary embodiment of the present invention includes a row address generator 312 and a column address generator 314 each generating a row address and a column address in order to store a, b, c, and d, the result values o the filtering operation, at desired positions of the frame memory 320. The pixel interleaving device 310 interleaves the pixel data of the values a, b, c, and d and stores the same by column of the macro block in the frame memory 320 by page.

Because the position of the pixel data is aligned according to the position of the macro block, the pixel interleaving device 310 changes the address for interleaving according to the position of the currently processed macro block. This method may be also performed in the same manner on a reference chrominance image, as well as on the reference luminance image.

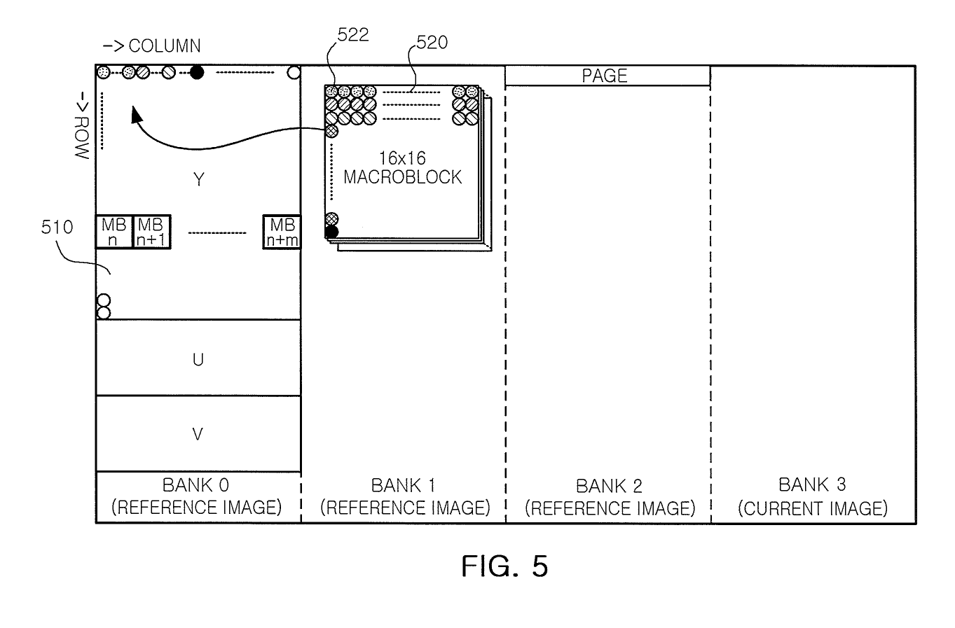

The method of interleaving the pixel data and storing the same with the pixel interleaving device 310 will be described in detail with reference to FIGS. 5 to 7, later.

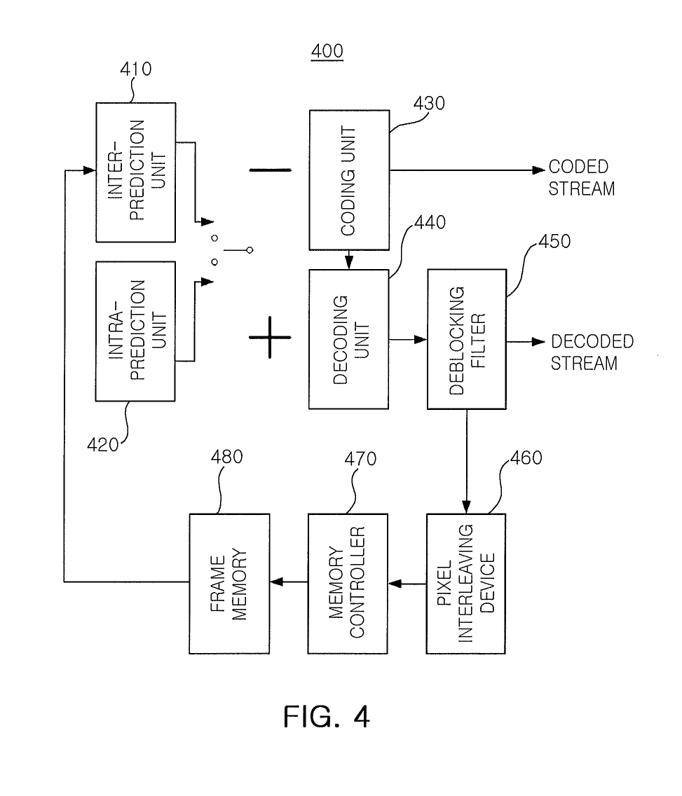

FIG. 4 is a schematic block diagram of a video codec system according to an exemplary embodiment of the present invention.

With reference to FIG. 4, a video codec system according to an exemplary embodiment of the present invention includes an inter-prediction unit 410, an intra-prediction unit 420, a coding unit 430, a decoding unit 440, a deblocking filter 450, a pixel interleaving device 460, a memory controller 470, and a frame memory 480, and the like.

The inter-prediction unit 410 estimates a motion between original images from a previous image to predict an image.

The intra-prediction unit 420 predicts an image in an original image.

The coding unit 430 codes the difference between the image predicted by the inter-prediction unit 410 or the intra-prediction unit 420 and the original image to create a coded stream.

The decoding unit 440 adds a residual value between the predicted image and the original image to the image predicted by the inter-prediction unit 410 or the intra-prediction unit 420 to restore the image.

In order to prevent the image from being distorted in a decoding operation, the deblocking filter 450 performs deblocking filtering on the finally restored image, outputs the filtered image to an external display device (not shown) and, at the same time, stores the filtered image in the frame memory (e.g., the SDRAM or the DDR SDRAM) 480. In this case, the image stored in the frame memory 480 is fed back to the inter-prediction unit 410 so as to be used to predict a next frame image.

The pixel interleaving device 460 according to an exemplary embodiment of the present invention is positioned between the deblocking filter 450 and the memory controller 470. When the memory controller 470 stores the filtered image in the frame memory 480, the pixel interleaving device 460 interleaves the filtered image by column so that the interleaved image can be stored in the frame memory 480.

Thus, when the inter-prediction unit 410 requests the image stored in the frame memory 480, the memory controller 470 can provide the image stored in the frame memory 480 to the inter-prediction unit 410 by minimizing read latency, and accordingly, the performance of the overall video codec system 400 can be improved.

FIG. 5 is a view for explaining the sequential process of storing pixel data present in one macro block in a page of a single bank by column according to an exemplary embodiment of the present invention.

With reference to FIG. 5, when pixel data 522 existing in a macro block 520 in a page 510 of a single bank is sequentially stored by column, the pixel data existing in one page can be consecutively read after a one time row active command without an additional delay time. Accordingly to this method, when a read command having a burst length (BL) greater than the CAS latency (CL) is given by the memory controller, the corresponding pixel data can be consecutively retrieved. This can be applied to a case in which pixel data of a reference image of a luminance (or Luma) component is read, and also applicable to a case in which pixel data of a reference image of a chrominance (or Chroma) component is read.

In general, although varying according to devices, the size of the page may range from 1K to 2K, and when 4 bytes (×32) per column is stored, a macro block of a luminance component having a 16×16 pixel size can store 16 to 32 bytes at the maximum level per page according to a size thereof, and a macro block of a chrominance component having a 8×8 pixel size can store 64 to 128 bytes per page.

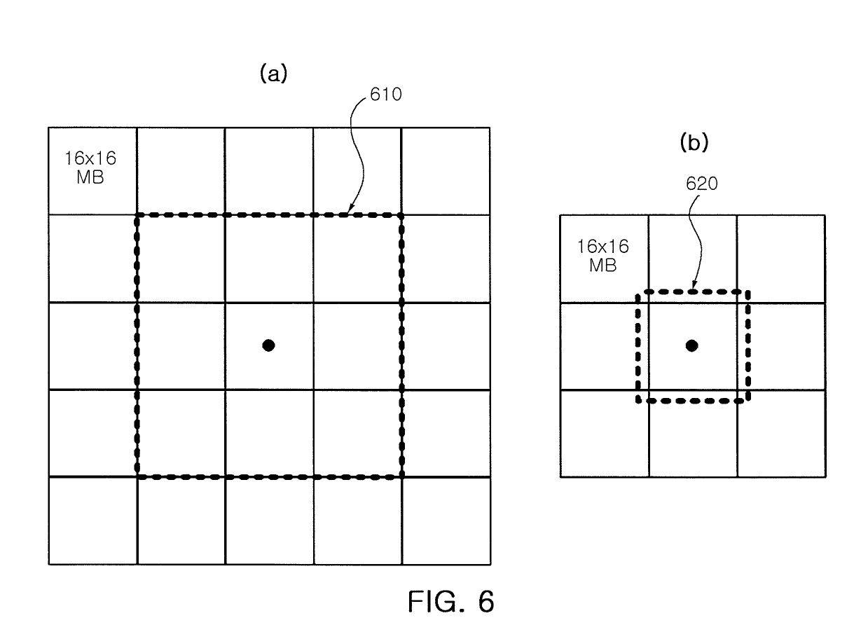

FIG. 6 is a view illustrating the number of macro blocks required for a motion estimation or motion compensation.

With reference to FIG. 6, (a) shows a reference image area 610 required for a motion estimation, and (b) shows a reference image area 620 required for a motion compensation. In case of a motion estimation or motion compensation, a minimum eight neighbor macro blocks, including a macro block of a current position, based on the position of the current macro block according to an estimated motion vector, is required, and a total of nine macro blocks of a reference image must be read.

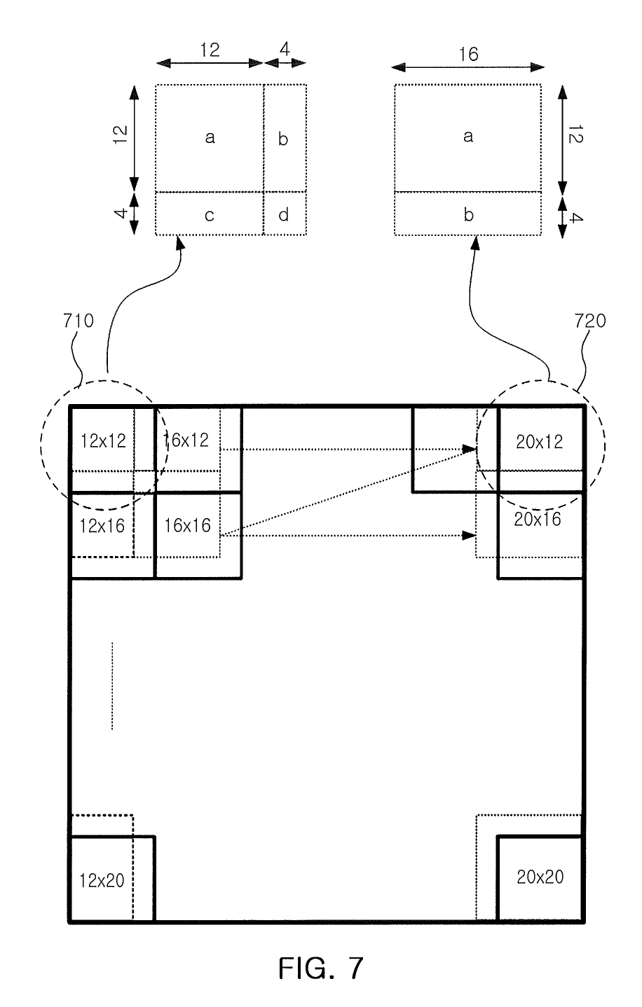

When the method of interleaving pixels by macro block (or in the units of macro blocks) according to an exemplary embodiment of the present invention is employed, even in the case in which nine macro blocks are present in different pages counted, only a delay time (54 cycles when the conditions of FIG. 2 are counted) of (t_{RCD}+CL)×9 is required, obtaining a 81.25 percent of cycle reduction effect when compared with a general case of (t_{RCD}+CL)×48 (288 cycles when the conditions of FIG. 2 are counted). To this end, the pixel values of the reference image, namely, the filtering results of the restored image must be interleaved and stored in the frame memory. In this case, in general, in a filter calculation, adjacent pixel data at a right boundary of a macro block and adjacent pixel data at a lower boundary of a macro block are referred to according to the raster order of an image, so even when one macro block is processed in a pipe line of a macro block level, a full reference macro block is not created yet. This will be described in detail with reference to FIG. 7.

FIG. 7 is a view illustrating the overall reference frame including sizes of reference macro blocks of a filtered luminance image according to positions of the macro blocks.

As shown in FIG. 7, the sizes of reference images output after having been filtered may vary depending on the positions of macro blocks. A reference macro block 710 at an upper left end may be stored at a point in time when the filtering of macro blocks a, b, c, and d is completely finished, and a reference macro block 720 at an upper right end may be stored at a point in time when the filtering of macro blocks a and b is completely finished. Thus, addresses may be assigned to the non-processed pixel values b, c, and d of the macro block and stored at desired positions of a page of the frame memory.

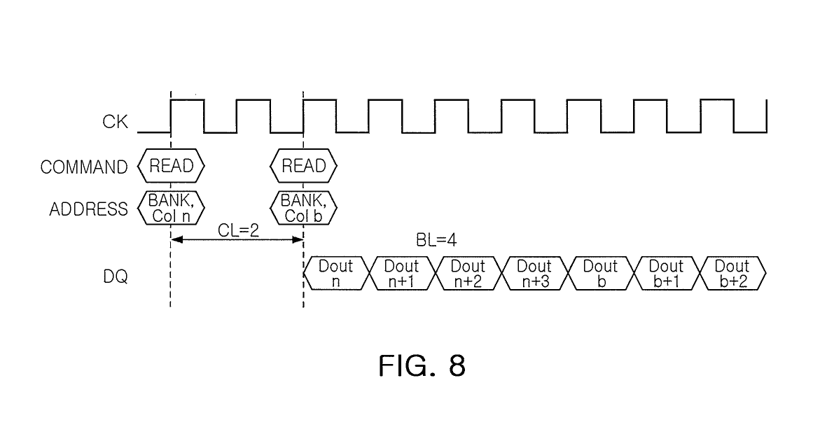

FIG. 8 is a view for explaining the process of retrieving data according to a read command according to an exemplary embodiment of the present invention.

As shown in FIG. 8, when a read command (READ), whose burst length (BL) of data that can be read once from the memory area of a page of one row is greater than the CAS latency (CL), is consecutively given, data can be consecutively read after the lapse of a delay time (or latency) of T_{READ} following the row active command (ACTIVE), without any additional delay time.

Based on this operational principle, in an exemplary embodiment of the present invention, the pixel data of the reference image (or reference frame), namely, a filter output of a reconstruction image required for an image processing is interleaved by column of a macro block, aligned by page within a single bank of the frame memory and stored. And then, when a motion estimation or a motion compensation of a next frame is performed, the required reference image is consecutively read, thereby reading data without a delay time according to a row active command (ACTIVE).

As set forth above, according to exemplary embodiments of the invention, pixel data of a reference image is interleaved by column of a macro block so as to be aligned by page within a single bank of a frame memory and stored, and then, the pixel data of the reference image required for a motion estimation or a motion compensation of a next frame is read by a maximum burst length. Thus, read latency according to a row active command can be eliminated to thus improve performance of the overall video codec system.

In addition, data is consecutively read by a maximum burst length within a single bank of the frame memory, the effect of multi-bank interleaving can be obtained b using a general single port memory controller, without having to use a memory controller supporting special multi-port bank interleaving.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for interleaving pixels of a reference image within a single bank of a frame memory, the method comprising:
interleaving pixel data of a reference image as a filter output of a restoration image required for video processing by column of a macro block; and
storing the interleaved pixel data within a single bank of a frame memory by page.

2. The method of claim 1, wherein, in the storing of the interleaved pixel data by page, the pixel data of the reference image is stored at a desired position in the frame memory according to pre-set column addresses and row addresses.

3. An apparatus for interleaving pixels of a reference image within a single bank of a frame memory, the apparatus comprising:
a column address generator generating a column address for storing pixel data of a reference image as a filter output of a restoration image required for video processing in a frame memory; and
a row address generator generating a row address for storing the pixel data of the reference image in the frame memory,
wherein the pixel data of the reference image is interleaved by column of a macro block according to a column address and a row address generated from the column address generator and the row address generator, respectively, and stored within the single bank of the frame memory by page.

4. A video codec system comprising:
an inter-prediction unit predicting an image by estimating a motion between original images from a previous image;
an intra-prediction unit predicting an image in the original image;
a coding unit coding the difference between the image predicted by the inter-prediction unit or the intra-prediction unit and the original image to create a coded stream;
a decoding unit adding a decoded residual value to the image predicted by the inter-prediction unit or the intra-prediction unit to restore the image;
a deblocking filter filtering the restored image to eliminate a blocking phenomenon;
a pixel interleaving device interleaving pixel data of the filtered image by row of a macro block;
a frame memory storing the interleaved pixel data of the image in a single bank by page; and
a memory controller storing the interleaved pixel data of the image in the frame memory, and providing the pixel data stored in the frame memory to the inter-prediction unit according to a consecutive read command upon receiving a corresponding request from the inter-prediction unit.

5. The system of claim 4, wherein the read command is a command having a burst length greater than the CAS latency.

6. The system of claim 4, wherein the pixel interleaving device comprises:
a column address generator generating a column address for storing the interleaved pixel data of the image in the frame memory; and
a row address generator generating a row address for storing the interleaved pixel data of the image in the frame memory,
wherein the interleaved pixel data of the image is stored at a desired position in the frame memory according to a column address and a row address generated by the column address generator and the row address generator, respectively.
